(19) United States
(12) Patent Application Publication
(10) Pub. No.: US 2002/0111869 A1
(43) Pub. Date: Aug. 15, 2002

(54) Method and apparatus for remote data collection of product information using a communications device

(76) Inventors: Brian Shuster, Los Angeles, CA (US); Andrew Bruce Rifkin, Rolling Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/043,673

(22) Filed: Jan. 9, 2002

Related U.S. Application Data
(60) Provisional application No. 60/262,496, filed on Jan. 16, 2001.

(51) Int. Cl. G06F 17/60

(52) U.S. Cl. 705/23; 705/22

(57) ABSTRACT

The present invention provides a system through which a standard communications device can be modified to enable scanning of product barcodes in order to enable data collection of product information at a remote server site. Once this data collection of product information is complete, the user can perform various functions, as will be described in further detail. Advantages of the invention include providing users with the capability to implement product replenishment at a verified lowest price. In addition, price comparisons may be used in accordance with the teachings of the present invention, as well as the enablement of a mobile marketplace. Moreover, the present invention may simply be used to track desired products or for providing additional product information.

### RELATED APPLICATION

This application claims the benefit of U.S. Provisional Application No. 60/262,496 filed Jan. 16, 2001.

### FIELD OF THE INVENTION

The present invention relates generally to consumer commerce in the modem day marketplace. In particular, the invention relates to a method and apparatus for automated remote data collection of product information using a communications device.

### BACKGROUND OF THE INVENTION

Consumer commerce in the modem day marketplace has been greatly facilitated by the advent of online purchase of consumer products. Using the Internet, a consumer can easily search out and purchase certain desired products. However, the search for products can sometimes become unbearable as the user filters through various pages of product information or at times, fails to find a means for purchase of produce via the Internet. Currently, there are various products which are not available for purchase via the Internet. Consequently, consumers are forced to venture out and locate the products within their communities of local supermarkets and various consumer shops.

During such purchasing, the consumer may desire various product information and product comparisons regarding a desired product for purchase. Although store employees may occasionally provide a source for product information, there is currently no means for price comparison. Accordingly, the user must either assume the product is at the lowest price available or visit several stores and make product comparisons. Depending on the number of products desired by the consumer, it is easy to see that this process eventually becomes unbearable. This effort required by consumers to purchase products at the lowest price available eventually is very daunting to any consumer. Ideally, consumers could simply replenish products without leaving their home and be assured that the price charged for the product is the lowest price available.

From a seller's standpoint, a seller that travels to various sites in order to sell products creates, in essence, a mobile marketplace. Depending on the frequency with which the seller must travel, it is possible that the inventory within the seller's mobile marketplace must be kept by hand as computers for tracking such information may become cumbersome. In fact, having the capability to not only track the sales of products within an inventory, but also to be able to accept credit cards, instead of being limited to cash transactions, would be advantageous to the seller.

Therefore, there remains a need to overcome one or more of the limitations in the above-described existing art, some of which may be satisfied by the inventive structure and method described hereinafter.

### SUMMARY OF THE INVENTION

The present invention overcomes the problems in the existing art described above by providing a method and apparatus for automated remote data collection of product information using a standard communications device. The present invention provides a system through which a standard communications device can be modified to enable scanning of standard retail product barcodes in order to enable data collection of product information at a remote server site. Once this data collection of product information is complete, the user can perform various functions, as will be described in further detail below.

In one embodiment, the present invention enables the use of a wireless communications device to scan barcodes appearing on products and generate a transaction at a remote site for purchase of the product. Once the transaction is complete, the user is billed for the product and the product is mailed to the user. Conversely, the product information may be used to perform price comparison when browsing items within a store. Alternatively, the teachings of the present invention may be used to implement a mobile marketplace which can create both cash, as well as credit card transactions, for purchase of items and make modifications to inventory, which track the various sales of products.

Advantages of the invention include providing users with the capability to implement product replenishment at a verified lowest price. In addition, price comparisons may be used in accordance with the teachings of the present invention, as well as the enablement of a mobile marketplace. Moreover, the present invention may simply be used to track desired products or for providing additional product information.

### BRIEF DESCRIPTION OF THE DRAWINGS

The present invention is illustrated by way of example, and not by way of limitation, in the figures of the accompanying drawings and in which:

FIG. 1 depicts a block diagram illustrating a system in which a remote product data collection system, in accordance with the present invention, may be implemented;

FIG. 2 is a block diagram illustrating a conventional communications device connected with a barcode scanning device, in accordance with an embodiment of the present invention;

FIG. 3 is a block diagram illustrating a microprocessor of the barcode scanning device, as depicted in FIG. 2, in accordance with a further embodiment of the present invention;

FIG. 4 depicts a communications device incorporating the barcode scanning device, as depicted in FIG. 2, in accordance with a further embodiment of the present invention;

FIG. 5 depicts a block diagram further illustrating the remote product data collection apparatus, as shown in FIG. 1;

FIG. 6 is a block diagram further illustrating a communications interface, as depicted in FIG. 5, in accordance with a further embodiment of the present invention;

FIG. 7 is a flowchart, illustrating methods for performing remote product data collection, in accordance with an embodiment of the present invention;

FIG. 8 is a flowchart illustrating methods for establishing a connection between a user and a transaction server computer, in accordance with a further embodiment of the present invention;

FIG. 9 is a flowchart illustrating methods for performing user verification of a user attempting to establish a connection to the transaction server computer, in accordance with the further embodiment of the present invention;

FIG. 10 is a flowchart illustrating methods for scanning a barcode appearing on a product and converting an optical barcode signal into an audio barcode signal, which is transmitted to the transaction server computer, in accordance with an exemplary embodiment of the present invention;

FIG. 11 is a flowchart illustrating methods performed by the transaction server computer in response to receiving audio barcode signals from a user, in accordance with an exemplary embodiment of the present invention; and

FIG. 12 is a flowchart illustrating methods for processing product data decoded from an audio barcode signal as directed by an instruction provided by the user, in accordance with an exemplary embodiment of the present invention.

### DETAILED DESCRIPTION

The present invention overcomes one or more of the problems in the existing art described above by providing a method and apparatus for automated remote data collection of product information using a standard communications device. In the following description, for purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form in order to avoid obscuring the details of the present invention.

In an embodiment, the methods of the present invention are embodied in machine-executable instructions. The instructions can be used to cause a general-purpose or special-purpose processor that is programmed with the instructions to perform the methods of the present invention. Alternatively, the methods of the present invention might be performed by specific hardware components that contain hardwired logic for performing the methods, or by any combination of programmed computer components and custom hardware components.

The present invention may be provided as a computer program product which may include a machine or computer-readable medium having stored thereon instructions which may be used to program a computer (or other electronic devices) to perform a process according to the present invention. The computer-readable medium may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

Accordingly, the computer-readable medium includes any type of media/machine-readable medium suitable for storing electronic instructions. Moreover, the present invention may also be downloaded as a computer program product. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

System Architecture

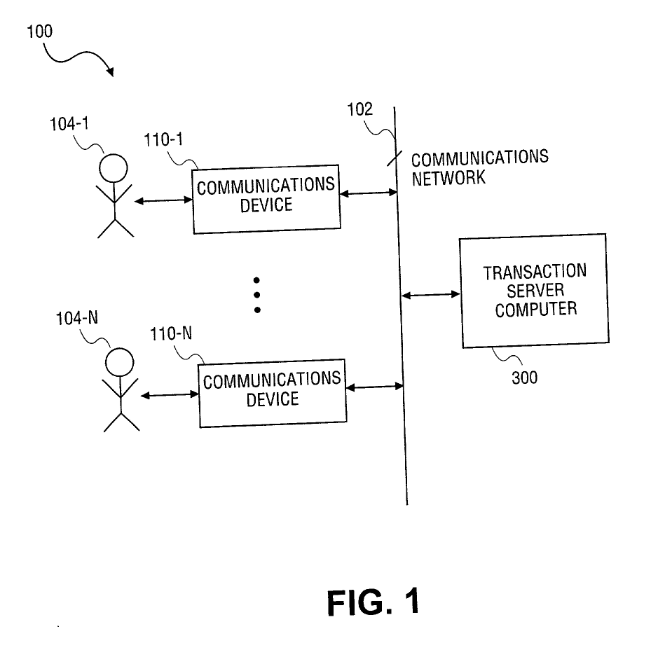

FIG. 1 depicts one embodiment of a remote product data collection system architecture 100 in which the systems and methods of the present invention may be incorporated. One or more communications devices 110 (110-1, . . . , 110-N) are connected through a communications network 102 (such as a public switch telephone network (PSTN), a wireless communications network, an Intranet, a LAN, a WAN (such as the Internet) or the like to a host computer or web server (“transaction server computer”) 300. Persons skilled in the art will recognize that the transaction server computer 300 may include one or more computers working together to provide the product data collection computer functions described herein.

One or more users 104 (104-1, . . . , 104-N) each have a communications device 110 that is connected to the communications network 102. In accordance with the teachings of the present invention, a user 104 can transmit audio tones of a scanned retail product barcode via the communications device 110, which is received by the transaction server computer 300 via a communication interface 308. As described in further detail below, the transaction server computer 300 can then decode the audio barcode tones, collect relevant product data and process the product data in accordance with a user instruction.

The communications network 102 generally refers to any type of wire or wireless link enabling the transmission of voice data such as, but not limited to, a public switched telephone network, a wireless communications network, a local area network, a wide area network, a combination of network or the like. The communications devices 110 generally refer to any type of device capable of transmitting audio barcode signals scanned by a user and providing the audio barcode tone signals to a destination via a communications network, such as the communications network 102. In an embodiment of the present invention, the communications network 102 is a wireless communications network and the communications device 110 is a cellular phone.

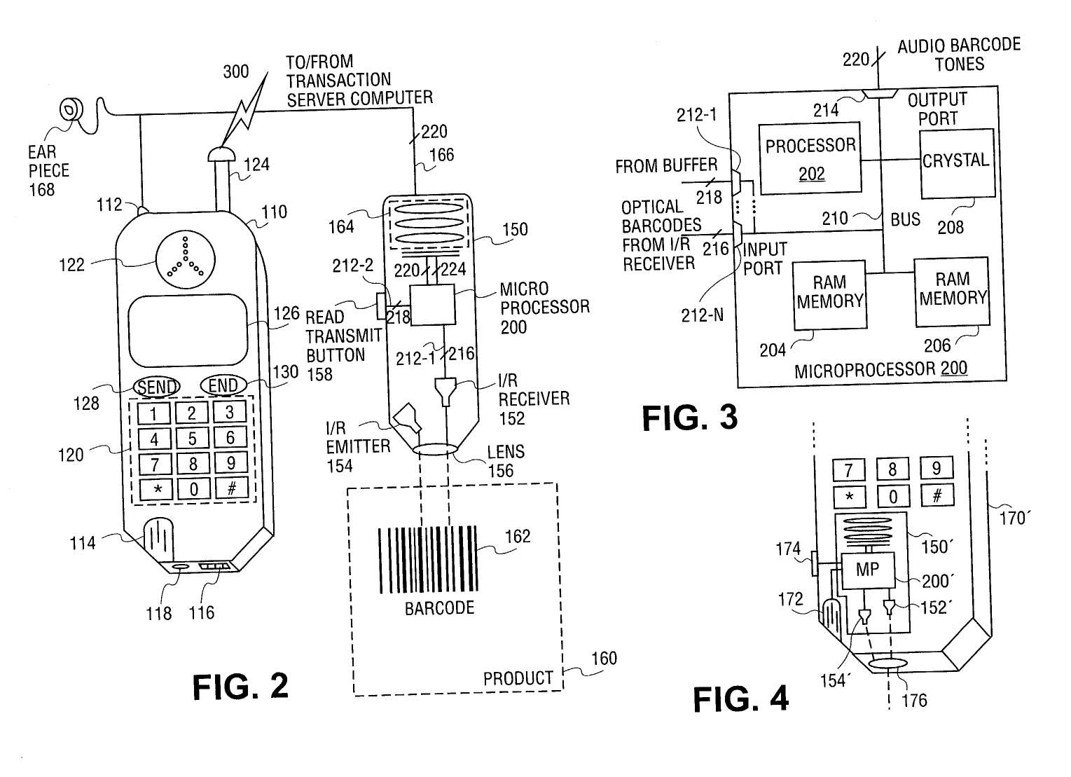

Referring now to FIG. 2, modification of a standard communications device 110 in order to implement barcode scanning, in accordance with an embodiment of the present invention, is depicted. The communications device 110, as depicted in FIG. 2, is, for example, a wireless cellular phone, as known to those skilled in the art. However, those skilled in the art will appreciate that the present invention is not limited to wireless cellular phones and can include any wireless communications device, such as a personal data assistant (PDA), a computer, a standard telephone with a wireless headless or the like. Also, the cellular phone 110 includes an earphone/microphone jack 112, as well as a voice transmitter 122 and a voice speaker receiver 114.

In order to implement the teachings of the present invention, a barcode wand 150 is attached to the earphone jack 112 of the cellular phone 110. The barcode wand 150 includes a universal adapter cord 166 that plugs into the earphone jack 112 of the cellular phone 110. The cord 166 also includes an earpiece 168. The barcode wand 150 further includes an infrared (I/R) emitter 154 for illuminating a retail product barcode 162 of a product 160. Retail product barcodes include, for example, three of nine barcodes, ISBN barcodes, and the like. An I/R receiver 152 reads the illuminated barcodes through a lens 156 in order to generate an optical barcode signal 216, which is read by the microprocessor 200.

The barcode wand 150 further includes a read/transmit button 158 for implementing barcode wand 150 read mode and transmit mode, as described in further detail below. The barcode wand 150 further includes button battery cells 164 for powering the barcode wand 150. Consequently, once the I/R receiver 152 provides the optical barcode signal to the microprocessor 200, the microprocessor 200 converts the optical barcode signal into audio barcode tones to form an audio barcode signal, as will be described in further detail below.

The audio barcode signal, or audio barcode tones, 220 are then transmitted via the cord 166 to the microphone jack 112 of the cellular phone 110. Thus, using the barcode wand 150, a user can scan barcodes 162 of various products 160 and is able to hear a beep for each validly scanned barcode using the earpiece 168. Using the read/transmit button 158, the user can scan various product barcodes 162, which are stored by the microprocessor 200, in what is referred to as “read mode”.

Once the user is done scanning each desired product barcodes, the user can then contact the transaction server computer 300 by dialing a phone number of the transaction server computer 300. Once a connection is made with a transaction server computer 300, the user 104 presses the read/transmit button 158 and transmits each scanned audio barcode signal(s) to the transaction server computer 300 for additional processing, as will be described in further detail below.

Referring now to FIG. 3, a block diagram further illustrating the microprocessor 200 of the barcode wand 150 (FIG. 2) is depicted. The microprocessor 200 includes a processor 202, which is coupled to a crystal 208, a random access memory (RAM) 204 and a read only memory (ROM) 206 via a bus 210. The microprocessor 200 also includes one or more input ports 212 (212-1, . . . , 212-N). Via the input ports 212, the microprocessor 200 receives a digital input 218 from the read/transmit button 158, as well as the optical product barcodes 216, which are scanned by the barcode wand 150.

Once the optical barcode signals 216 are received, the processor 202 converts the optical barcode signals 216 into audio barcode tones 220, which are stored in the random access memory 204. Once the microprocessor 200 is put into “transmit mode”, based on the input 218 received from the read/transmit button 158, each audio barcode tone 220 stored in the random access memory is transmitted to the attached cellular telephone 110 via the cord 166.

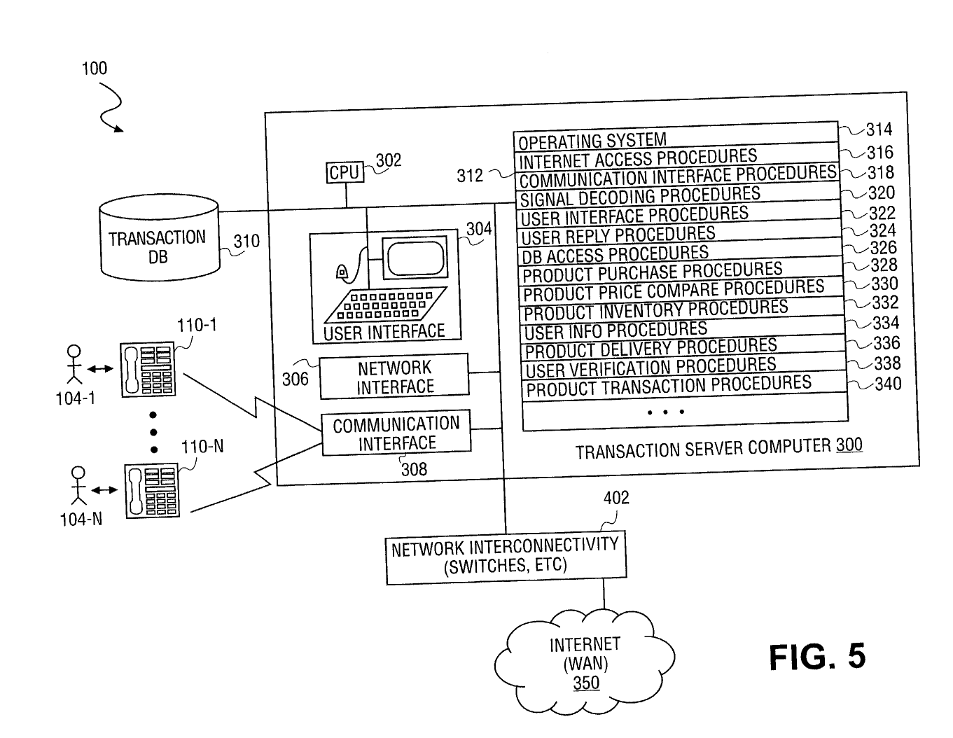

Referring now to FIG. 4, a block diagram of a lower portion of a cellular telephone 170 is depicted, in accordance with a further embodiment of the present invention. The cellular telephone 170 includes a barcode wand 150′, which is integrated into the design of the cellular telephone 110. As such, the read/transmit button 174 is built into the telephone, and the microprocessor 200′ of the barcode wand 150′ is attached to the voice receiver 172 of the cellular telephone 170. Consequently, using the cellular telephone 170, a user can scan barcodes via lens 176, which are read by the I/R receiver 152′ and stored by the microprocessor 200′. Processing of the audio barcode tones 220 transmitted by the cellular telephone 110 to the transaction server computer 300 is now described, with reference to FIG. 5.

FIG. 5 further illustrates the remote product data collection system 100, including the transaction server computer 300. The transaction server computer 300 includes a central processing unit (CPU) 302, a user interface 304, a network interface 306, a communications interface 308, a transaction database (DB) 310 and a memory 312. The transaction server computer 300 can be any type of computing device, such as, but not limited to, desktop computers, work stations, lap tops and/or mainframe computers.

The communications interface 308 is used to communicate with users 104, as well as other system resources not shown. The communications interface 308 receives audio barcode tones as well as processing instructions provided by user 104 through the communications device 110, which is provided over the communications network 102. The communications interface 308 provides digitized product barcode signals to the transaction server computer 300 for decoding the barcode signals, including voice processing, speech recognition and text-to-speech processing.

The memory 312 of the transaction server computer 300 may be implemented as RAM (random access memory) or a combination of RAM and non-volatile memory, such as one or more magnetic disk storage units, memory modules, storage volumes, or the like. The memory can contain any of the following:

an operating system 314;

internet access procedures 316;

communications interface procedures 318 for converting audio barcode signals and user instructions into a digital format;

signal decoding procedures 320 for decoding received digitized barcode signals;

user interface procedures 322 for requesting and receiving data processing instructions from the user;

user reply procedures 324 for providing output, required by the received instructions, to the user 104;

database (DB) access procedures 326 for querying the database 310 in order to return desired product information as well as generating transactions for tracking product sales, purchases, product description information and inventory;

product purchase procedures 328 for ascertaining a desired product, ordering the desired product, charging the user 104 for the product and delivering the product to the user 104;

product price comparison procedures 330 for finding the lowest price possible for a product scanned by the user 104 and providing the lowest price to the user 104;

product inventory procedures 332 for tracking purchase and sale of products from inventory to enable a mobile market place;

user information procedures 334 for tracking products desired by user 104 as well as retrieving product description information;

product delivery procedures 336 for coordinating delivery of product(s) purchased by the user 104;

user verification procedures 338 for verifying the identity of the user 104, credit card purchase information and product shipping information;

product transaction procedures 340 generating sales transactions, such as sales and purchases in the transaction database 310; and

other procedures and files.

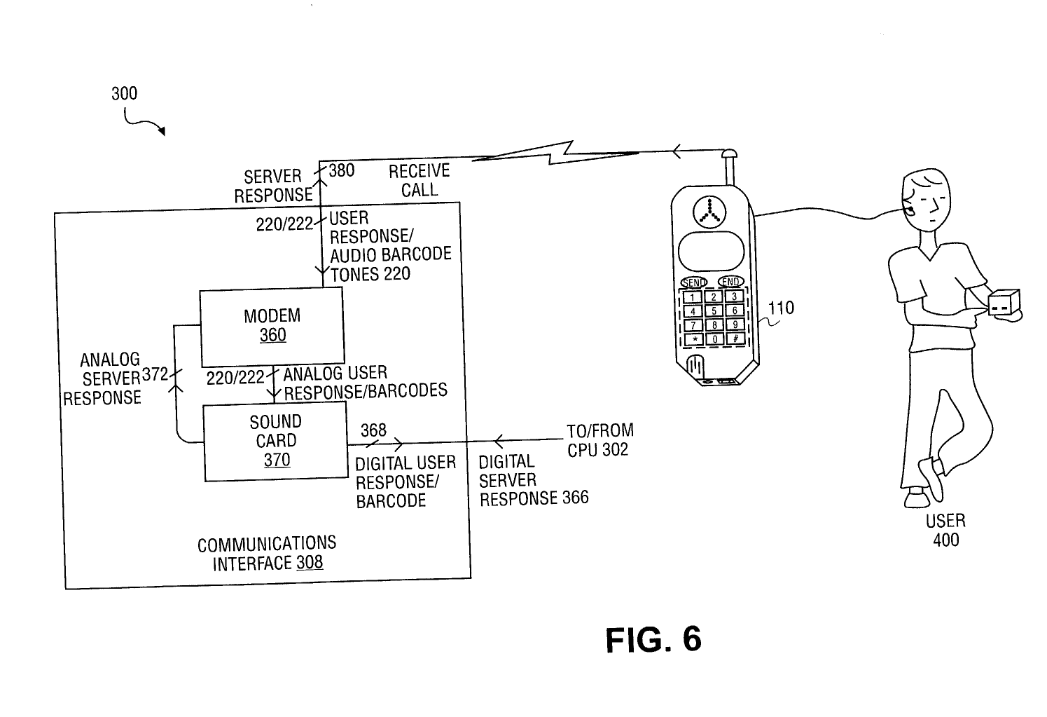

Referring now to FIG. 6, the communications interface 308, as depicted in FIG. 5, is now further illustrated in accordance with an exemplary embodiment of the present invention. The communications interface 308 includes a modem 360, as well as the sound card 370. The modem 360 initially receives a call from a user 400. Once the call is accepted, the sound card may receive digital server responses 366 for verifying the identity of the user 400. The digital server responses 366 are converted into an audio server response 372 by the sound card 370, which is transmitted to the user 400 via the modem 360.

User responses, either via voice commands or via keys pressed on the cellular telephone 110, are received by the modem 360 and transmitted to the sound card 370. The user response 322 is then converted to a digital user response and transmitted to the CPU 302 of the transaction server computer 300. Once verification of the user is complete, the user can begin transmitting stored audio barcode tones 220. In one embodiment, the verification includes a request for product processing instructions.

The audio barcode tones 220 are received by the modem 360 and transmitted to the sound card 370. The sound card 370 then converts the audio barcode tones 220 into digital barcode signals 368, which are transmitted to the CPU 302. The CPU 302 can then decode the digital barcode signals 368 and ascertain the product desired by the user 104. The transaction server computer 300 can then process the decoded product and relevant information in accordance with processing instructions received from the user 400. Finally, the server 300 can generate any required information based on the instruction provider by the user 104, which is converted into a WAV file by the sound card 370 and transmitted to the user 104. Procedural methods for implementing the teachings of the present invention are now described.

Operation

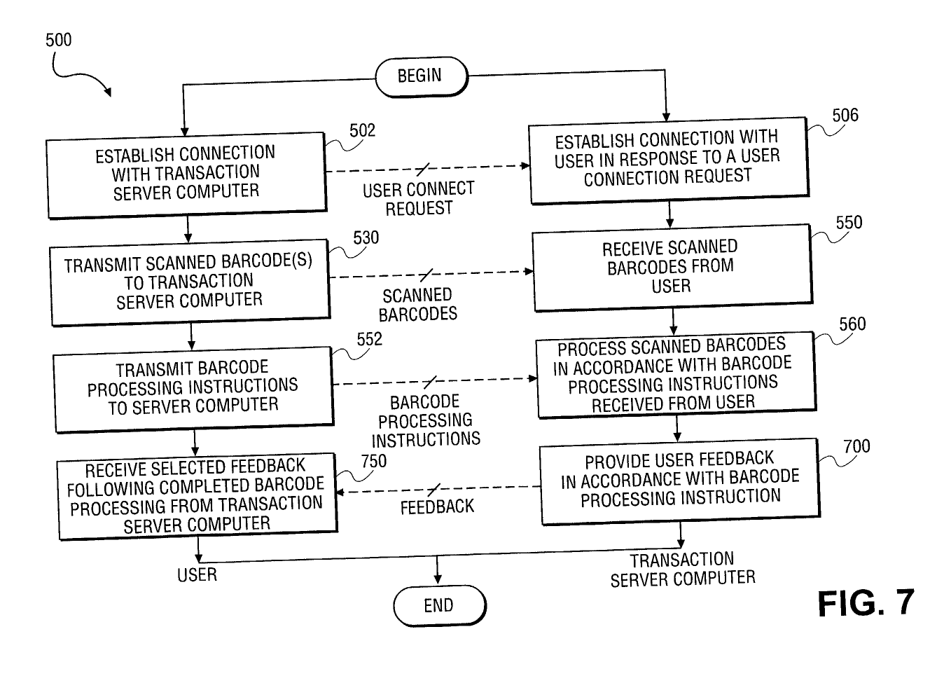

Referring now to FIG. 7, a method 700 is depicted for enabling remote product data collection in accordance with the teachings of the present invention, for example, in the remote product data collection system 100, as depicted in FIGS. 1 and 5. At process block 502, a user 104 establishes a connection with the transaction server computer 300. At process block 506, in response to a user connection request, the transaction server computer 300 establishes a connection with the user 104 using the user verification procedures 322. At process block 530, scanned audio barcode tones are transmitted to the transaction server computer 300. At process block 550, the transaction server computer 300 receives scanned product barcodes from the user 104.

Once the scanned product barcodes are received, process block 552 is performed. At process block 552, the user transmits barcode processing instructions to the transaction server computer 300. Next, at process block 560, the transaction server computer 300 processes decoded audio barcode signals in accordance with the barcode processing instructions received from the user 104. At process block 700, the transaction server computer provides the user feedback in accordance with the barcode processing instruction using the user reply procedures 324. Finally, at process block 750, the user 104 receives selected feedback following completed barcode processing from the transaction server computer 300.

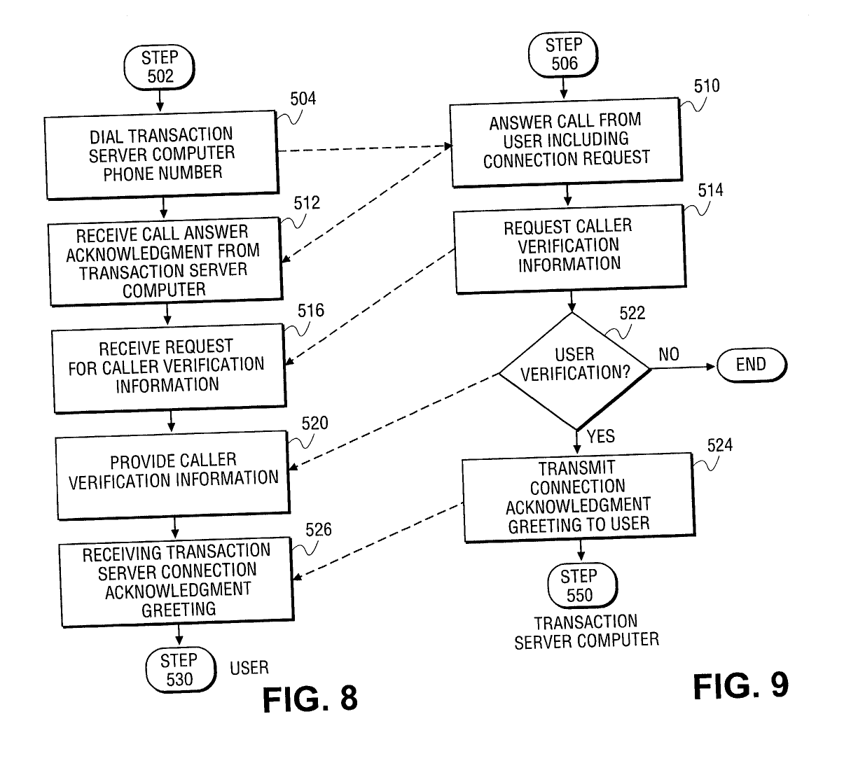

Referring now to FIG. 8, additional method methods for establishing a connection with the transaction server 300 of method 502, as depicted in FIG. 7, are illustrated. At process block 504, the user dials the transaction server computer telephone number. At process block 512, the user receives a call answer acknowledgement from the transaction server computer 300. At process block 516, the user receives a request for caller verification information, including for example, a PIN number or caller ID verification. At process block 520, the user 104 provides the caller verification information to the transaction server computer 300. Finally, at process block 526, the user 104 receives a transaction server connection acknowledgement greeting.

Referring now to FIG. 9, additional method methods for performing the connection establishment of method 506, as depicted in FIG. 7, are further illustrated. At process block 510, the transaction server computer 300 answers a call from a user 104, including a connection request. At process block 514, the transaction server computer 300 requests caller verification information from the user 104. At process block 522, the transaction server computer 300 verifies whether the user should be granted access to the system 100 using the user verification procedures 338. At process block 524, when a user 104 is granted access to the system 100, a transmit connection acknowledgement greeting is transmitted to the user 104; otherwise, the system will deny the connection request from the user 104.

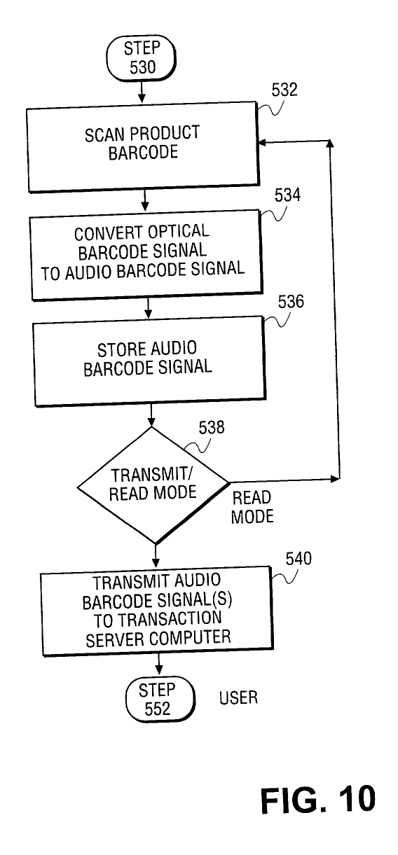

Referring now to FIG. 10, additional method methods for transmitting scanned barcodes to the transaction server computer of method 530 are illustrated. At process block 532, the user 104 will scan a standard retail product barcode, for example as depicted in FIG. 2. The barcode wand 150 will convert the three of nine product barcode, ISBN product barcode or the like, into a series of barcode tones at process block 534. The conversion of the optical barcode signals read by the I/R receiver 152 is necessary for transmitting the audio barcode tones 220 via a wireless communications device, such as a cellular phone. Once conversion of the audio barcode tones 220 is complete, at process block 536, the barcode wand 150 stores the audio barcode tones 220. At process block 538, the barcode wand 150 determines whether it is in “read” mode or “transmit” mode. When the barcode wand is in “read” mode, methods 532 through 536 are repeated. Otherwise, at process block 540, the stored audio barcode tones are transmitted to the transaction server computer 300 via the cellular phone 110.

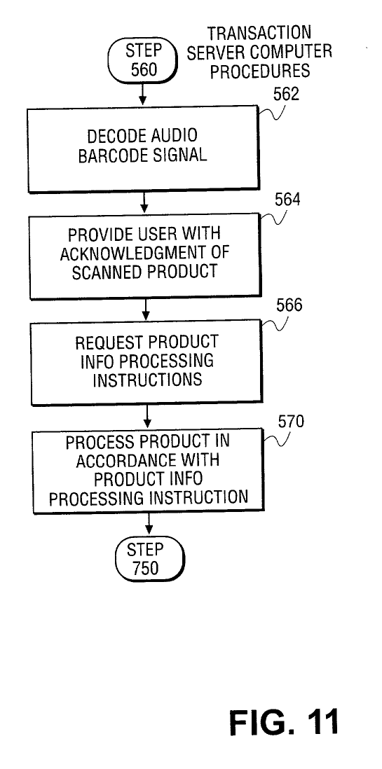

Referring now to FIG. 11, additional method methods for performing the processing of scanned product barcodes of method 560, as depicted in FIGS. 5 and 6, are further illustrated. At process block 562, the transaction server computer 300 decodes a digital version of the audio barcode tones 220 received from the user 104 using the signal decoding procedures 320. Decoding of the audio barcode tones will depend on the method used for encoding the optical barcode signal 218 into audio barcode tones 220 by the barcode wand 150. Based on this encoding method, decoding will provide a digital representation of the product barcode signal.

Once decoded, the digital product barcodes can then be interpreted by the transaction server computer 300 in order to determine the desired product and process the product as follows. At process block 564, the transaction server computer 300 provides the user 104 with an acknowledgement of the scanned product. At process block 566, the transaction server computer requests product information processing instructions from the user 104. In one embodiment, the user can provide the processing instructions either by entering numbers on the cellular phone keypad or by providing the transaction server computer 300 with a voice request. At process block 570, the transaction server computer 300 processes the product information in accordance with the product processing instruction received from the user 104.

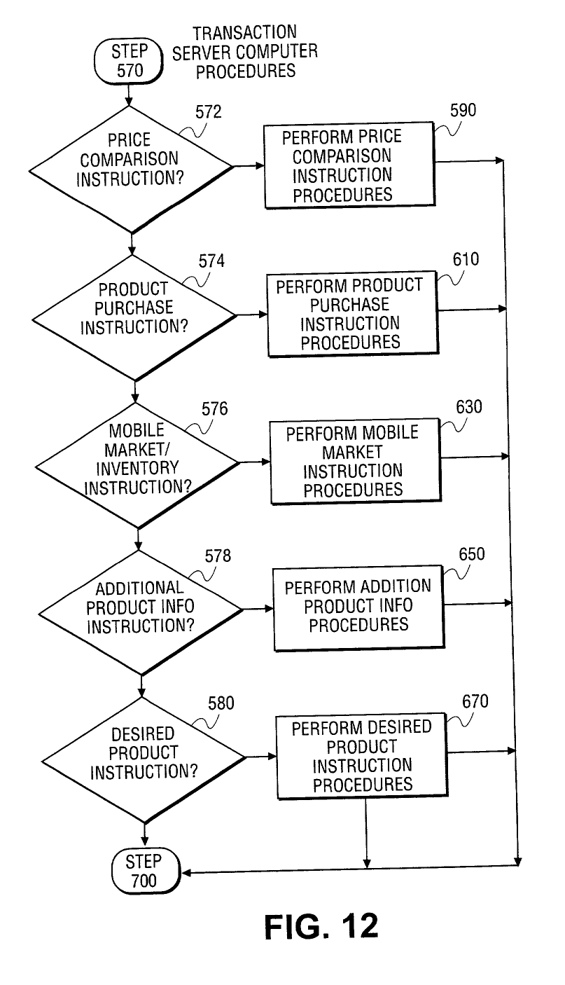

Finally, referring to FIG. 12, additional method methods are depicted for performing the product processing methods of method 570 as depicted in FIG. 11. At process block 572, the transaction server computer 300 determines whether the price comparising instruction was received. At process block 590, when the comparison instruction was received, the transaction server computer 300 performs price comparising instruction procedures 330, as described with reference to FIG. 5 to determine the lowest price available for the product.

Next, at process block 574, the transaction server computer 300 determines whether product purchasing instructions were received from the user. At process block 610, when product purchase instructions were received from the user, the transaction server computer 300 performs product purchase instruction procedures 328. These procedures 328 include, for example, determining a source for the product having a lowest price, ordering of the product, billing the user 104 for the desired product and coordinating delivery of the purchased product to the user 104. At process block 576, mobile market/inventory instructions are determined.

At process block 630, when mobile market or inventory instructions are received, the transaction server computer 300 performs mobile market instruction procedures 332. As described above, these procedures 332 include modifying inventory based on sale or purchase of a product, billing a user based on provided credit card information or cash, as well as determining and coordinating ordering needs for products which are nearly out of inventory. At process block 578, additional product information instructions are determined. At process block 650, the transaction server computer performs additional product information procedures 334. Such procedures include tracking products desired by the user or simply providing the user with additional product information in order to determine whether to purchase the product. Finally at process block 580, desired product instructions are determined. At process block 670, the transaction server computer performs desired product instruction procedures 334 for tracking or keeping track of products desired by the user 104.

Referring again to FIG. 12, those skilled in the art will appreciate that although the methods described include various product information processing instructions, those skilled in the art will realize that various additional product processing instructions are within the contemplation of the present invention, and as such, the instructions provided at FIG. 12 are provided as an example and should not be interpreted in a limiting sense.

Alternate Embodiments

Several aspects of one implementation of the remote product data location system for providing remote product purchase, information, mobile market inventory or the like have been described. However, various implementations of the remote data location system provide numerous features including, complementing, supplementing, and/or replacing the features described above. Features can be implemented as part of the scanning wand or as part of the communications device with a built-in scanning wand in different implementations. In addition, the foregoing description, for purposes of explanation, used specific nomenclature to provide a thorough understanding of the invention. However, it will be apparent to one skilled in the art that the specific details are not required in order to practice the invention.

In addition, although an embodiment described herein is directed to a remote data location system, it will be appreciated by those skilled in the art that the teaching of the present invention can be applied to other systems. In fact, systems for identification of products via encoded symbols are within the teachings of the present invention, without departing from the scope and spirit of the present invention. The embodiments described above were chosen and described in order to best explain the principles of the invention and its practical applications. These embodiment were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the present invention to the full extent indicated by the broad general meaning of the terms in which the appended claims are expressed.

Further, the method and system described hereinabove is amenable for execution on various types of executable mediums other than a memory device such as a random access memory. Other types of executable mediums can be used, such as but not limited to, a computer readable storage medium which can be any memory device, compact disc, or floppy disk.

Accordingly, although the present invention has been described with reference to a remote product data collection system, it is not limited to performing data collection services over the telephone. The present invention can be used for other electronic commerce purposes, other commodities, other types of products, and other types of services not explicitly listed. In addition, communications devices within the contemplation of the present invention include systems for wireless communications or any network capable of transmitting audio data. Moreover, performance, by a human operator, of the data collection procedures of the present invention is within the contemplation of the present invention.

The present invention provides many advantages over conventional systems. Advantages of the invention include providing users with the capability to implement product replenishment at a verified lowest price. In addition, price comparisons may be used in accordance with the teachings of the present invention, as well as the enablement of a mobile marketplace. Moreover, the present invention may simply be used to track desired products or for providing additional product information.

Having disclosed exemplary embodiments and the best mode, modifications and variations may be made to the disclosed embodiments while remaining within the scope of the invention.

What is claimed is:

1. A method comprising:
scanning one or more product barcodes;
converting the one or more scanned barcodes into audio tones; and
transmitting, via a communications device, the one or more scanned barcodes as the audio tones to a transaction server computer, such that the transaction computer processes the one or more barcodes in accordance with a barcode processing instruction.

2. The method of claim 1, further comprising:
transmitting a connection request to the transaction server computer, including verification information; and
when verified, receiving a connection request acknowledgment from the transaction server computer.

3. The method of claim 2, wherein transmitting the connection request further comprises:
dialing a transaction server computer phone number;
receiving a call answer acknowledgment from the transaction server computer;
receiving a request for caller verification information; and
providing the requested caller verification information to the transaction server computer.

4. The method of claim 1, wherein scanning product barcodes further comprises:
scanning a product barcode;
when a read mode is detected, storing the scanned product barcode; and
repeating the scanning and storing until a transmit mode is detected.

5. The method of claim 1, wherein converting the barcodes further comprises:
selecting a stored optical barcode signal from the one or more scanned product barcodes;
converting the optical barcode signal into an audio barcode signal to enable transmission via a voice communications device; and
repeating the selecting and converting for each stored optical barcode signal.

6. The method of claim 1, further comprising:
selecting a barcode processing instruction; and
transmitting the selected barcode processing instruction to the transaction server computer.

7. The method of claim 1, further comprising:
when the barcode processing instruction is a product purchase instruction, receiving product availability information, including one of a product price, a product source and one or more product delivery options; and
when the product is desired according to the received product availability information, providing a product purchase acknowledgement to the transaction server computer.

8. The method of claim 1, wherein the product purchase instruction is one of a product purchase instruction, a mobile market instruction, a desired product instruction and a product comparison instruction.

9. A computer readable storage medium including program instructions that direct a computer to function in a specified manner when executed by a processor, the program instructions comprising:
scanning one or more product barcodes;
converting the one or more scanned barcodes into audio tones; and
transmitting, via a communications device, the one or more scanned barcodes as the audio tones to a transaction server computer, such that the transaction computer processes the one or more barcodes in accordance with a barcode processing instruction.

10. The computer readable storage medium of claim 9, further comprising:
transmitting a connection request to the transaction server computer, including verification information; and
when verified, receiving a connection request acknowledgment from the transaction server computer.

11. The computer readable storage medium of claim 10, wherein transmitting the connection request further comprises:
dialing a transaction server computer phone number;
receiving a call answer acknowledgment from the transaction server computer;
receiving a request for caller verification information; and
providing the requested caller verification information to the transaction server computer.

12. The computer readable storage medium of claim 9, wherein scanning product barcodes further comprises:
scanning a product barcode;
when a read mode is detected, storing the scanned product barcode; and
repeating the scanning and storing until a transmit mode is detected.

13. The computer readable storage medium of claim 9, wherein converting the barcodes further comprises:
selecting a stored optical barcode signal from the one or more scanned product barcodes;
converting the optical barcode signal into an audio barcode signal to enable transmission via a voice communications device; and
repeating the selecting and converting for each stored optical barcode signal.

14. The computer readable storage medium of claim 9, further comprising:
selecting a barcode processing instruction; and
transmitting the selected barcode processing instruction to the transaction server computer.

15. The computer readable storage medium of claim 9, further comprising:
when the barcode processing instruction is a product purchase instruction, receiving product availability information, including one of a product price, a product source and one or more product delivery options; and
when the product is desired according to the received product availability information, providing a product purchase acknowledgement to the transaction server computer.

16. The computer readable storage medium of claim 9, wherein the product purchase instruction is one of a product purchase instruction, a mobile market instruction, a desired product instruction and a product comparison instruction.

17. A method comprising:
receiving one or more product barcodes as audio tones;
decoding the received audio tones to determine one or more products identified by the one or more product barcodes; and
performing product processing of the one or more products according to one or more received product processing instructions.

18. The method of claim 17, further comprising:
receiving a connection request from a user, including verification information; and
once verified, transmitting a connection request acknowledgment to the requesting user.

19. The method of claim 18, wherein receiving the connection request further comprises:
answering a call from the requesting user, including the connection request;
requesting verification information from the user; and
once the verification information is received, verifying that the user is authorized to establish a connection with the transaction server computer based on the received verification information.

20. The method of claim 17, wherein decoding the received audio tones further comprises:
selecting a received audio tone signal;
converting the selected audio tone signal into a product barcode to enable identification of a product associated with the decoded product barcode;
repeating the selecting and converting for each received audio tone; and
requesting a product processing instruction from the user.

21. The method of claim 17, further comprising:
when the received product processing instruction is a product purchase instruction, determining a source for the requested product having a lowest price;
once a product source is determined, providing product purchase information to the requesting user, including one of a product price, a product source and one or more product delivery options; and
once product purchase authorization is received, ordering the desired product for the user according to a received delivery and payment option.

22. The method of claim 17, wherein the product processing instruction is one of a product purchase instruction, a mobile market instruction, a desired product instruction and a price comparison instruction.

23. A computer readable storage medium including program instructions that direct a computer to function in a specified manner when executed by a processor, the program instructions comprising:
receiving one or more product barcodes as audio tones;
decoding the received audio tones to determine one or more products identified by the one or more product barcodes; and
performing product processing of the one or more products according to one or more received product processing instructions.

24. The computer readable storage medium of claim 23, further comprising:
receiving a connection request from a user, including verification information; and
once verified, transmitting a connection request acknowledgment to the requesting user.

25. The computer readable storage medium of claim 24, wherein receiving the connection request further comprises:
answering a call from the requesting user, including the connection request;
requesting verification information from the user; and
once the verification information is received, verifying that the user is authorized to establish a connection with the transaction server computer based on the received verification information.

26. The computer readable storage medium of claim 23, wherein decoding the received audio tones further comprises:
selecting a received audio tone signal;
converting the selected audio tone signal into a product barcode to enable identification of a product associated with the decoded product barcode;
repeating the selecting and converting for each received audio tone; and
requesting a product processing instruction from the user.

27. The computer readable storage medium of claim 23, further comprising:
when the received product processing instruction is a product purchase instruction, determining a source for the requested product having a lowest price;
once a product source is determined, providing product purchase information to the requesting user, including one of a product price, a product source and one or more product delivery options; and
once product purchase authorization is received, ordering the desired product for the user according to a received delivery and payment option.

28. The computer readable storage medium of claim 23, wherein the product processing instruction is one of a product purchase instruction, a mobile market instruction, a desired product instruction and a price comparison instruction.

29. An apparatus, comprising:
a processor having circuitry to execute instructions;
a communications interface coupled to the processor, the communications interface to receive audio barcode signal and to transmit received audio barcode signals to a transaction server computer;
a scanning device to scan product barcodes and provide scanned product barcodes to the processor; and
a storage device coupled to the processor, having sequences of instructions stored therein, which when executed by the processor cause the processor to:
scan one or more product barcodes,
convert the one or more scanned barcodes into audio tones, and
transmit, via a communications device, the one or more scanned barcodes as the audio tones to a transaction server computer, such that the transaction computer processes the one or more barcodes in accordance with one or more barcode processing instruction.

30. The apparatus of claim 29, wherein the processor is further caused to:
transmit a connection request to the transaction server computer, including verification information, and
when verified, receive a connection request acknowledge from the transaction server computer.

31. The apparatus of claim 30, wherein the instruction to scan product barcodes further comprises:
scanning a product barcode;
when a read load is detected, storing the scanned product barcode; and
repeating the scanning and storing until a transmit mode is detected.

32. The apparatus of claim 30, wherein the instruction to scan product barcodes further comprises:
selecting a stored optical barcode signal from the one or more scanned product barcodes;
converting the optical barcode signal into an audio barcode signal to enable transmission via a voice communications device; and
repeating the selecting and converting for each stored optical barcode signal.

33. An apparatus, comprising:
a processor having circuitry to execute instructions;
a communications interface coupled to the processor, the communications interface to receive audio barcode signals and to provide the received audio barcode signals to the processor; and
a storage device coupled to the processor having sequences of instructions stored therein, which when executed by the processor, cause the processor to:
receive one or more product barcodes as audio tones,
decode the received audio tones to determine one or more products identified by the one or more product barcodes, and
perform product processing of the one or more products according to a received product processing instruction.

34. The apparatus of claim 33, wherein the processor is further caused to:
receive a connection request from a user, including verification information; and
once verified, transmit a connection request acknowledge to the requesting user.

35. The method of claim 33, wherein the instruction to receive the connection request further causes the processor to:
answer a call from the requesting user, including the connection request;
request verification information from the user; and
once the verification information is received, verify that the user is authorized to establish a connection with the transaction server computer based on the received verification information.

36. The method of claim 33, wherein the instruction to decode the received audio barcode signals further causes the processor to:
select a received audio tone signal;
convert the selected audio tone signal into a product barcode to enable identification of a product associated with the decoded product barcode;
repeat the select and convert for each received audio tone signal; and
request a product processing instruction from the user.

37. A system comprises:
a transaction server computer to receive one or more audio barcode signals, decode the received audio barcode signals to identify one or more products, and process the one or more identified products according to one or more received product processing instructions; and
a communications device to scan one or more product barcodes that are transmitted to the transaction server computer along with one or more select product processing instructions.

38. The system of claim 37, wherein the communication device further comprises:
a processor having circuitry to execute instructions;
a communications interface coupled to the processor, the communications interface to receive audio barcode signal and to transmit received audio barcode signals to a transaction server computer;
a scanning device to scan product barcodes and provide scanned product barcodes to the processor; and
a storage device coupled to the processor, having sequences of instructions stored therein, which when executed by the processor cause the processor to:
scan one or more product barcodes,
convert the one or more scanned barcodes into audio tones, and
transmit, via a communications device, the one or more scanned barcodes as the audio tones to a transaction server computer, such that the transaction computer processes the one or more barcodes in accordance with one or more barcode processing instructions.

39. The system 37, wherein the transaction server computer further comprises:
a processor having circuitry to execute instructions;
a communications interface coupled to the processor, the communications interface to receive audio barcode signals and to provide the received audio barcode signals to the processor; and
a storage device coupled to the processor having sequences of instructions stored therein, which when executed by the processor, cause the processor to:
receive one or more product barcodes as audio tones,
decode the received audio tones to determine one or more products identified by the one or more product barcodes, and
perform product processing of the one or more products according to a received product processing instruction.
